(19) United States
(12) Patent Application Publication
(10) Pub. No.: US 2026/0129138 A1
(43) Pub. Date: May 7, 2026

(54) IMAGE PROCESSING APPARATUS AND IMAGE PROCESSING METHOD

(71) Applicant: SEIKO EPSON CORPORATION, TOKYO (JP)

(72) Inventors: Kohei KAJIWARA, SHIOJIRI-SHI (JP); Yoichiro MAKI, SHIOJIRI-SHI (JP)

(21) Appl. No.: 19/375,927

(22) Filed: Oct. 31, 2025

(30) Foreign Application Priority Data
Nov. 1, 2024 (JP) 2024-192739

(51) Int. Cl. H04N 1/60; H04N 1/64

(52) U.S. Cl. CPC H04N 1/6088; H04N 1/646

(57) ABSTRACT

An image processing apparatus includes a determination section that uses a color determination threshold and a monochrome determination threshold to determine whether a manuscript is a color manuscript or a monochrome manuscript, and an adjustment section that adjusts the color determination threshold and the monochrome determination threshold. The determination section accepts a determination instruction, upon determining that a color level of the manuscript is within a threshold interval region between the color determination threshold and the monochrome determination threshold, both inclusive. The adjustment section adjusts the color determination threshold or the monochrome determination threshold, based on the determination instruction. The adjustment section changes the color determination threshold and the monochrome determination threshold to a color/monochrome determination threshold, when a difference between the color determination threshold and the monochrome determination threshold is less than or equal to a predetermined value.

The present application is based on, and claims priority from JP Application Serial Number 2024-192739, filed Nov. 1, 2024, the disclosure of which is hereby incorporated by reference herein in its entirety.

### BACKGROUND

### 1. Technical Field

The present disclosure relates to an image processing apparatus and an image processing method.

2. Related Art

An image processing apparatus having an automatic color selection function has been known. The automatic color selection function is a function of automatically determining whether an input image is a color image or a monochrome image. An image processing apparatus described in JP-A-2001-268379 determines whether an image is a color image or a monochrome image by comparing the color level of the image data with a boundary value. The boundary value is an example of a determination value. The image processing apparatus may determine whether the image is a color image or a monochrome image in a boundary region mode in which a color boundary value and a monochrome boundary value are set. In the boundary region mode, when the color level of the image data is in a boundary region between the color boundary value and the monochrome boundary value, the image processing apparatus changes the boundary values in accordance with an operator's designation.

Depending on the color level of an input image, the operator may repeat adjusting and changing the boundary values until desired determination values are obtained.

### SUMMARY

The image processing apparatus of the present disclosure includes a scanning section that reads a manuscript; a determination section that uses a color determination threshold and a monochrome determination threshold to determine whether the manuscript is a color manuscript or a monochrome manuscript, the monochrome determination threshold being different from the color determination threshold; a storage section that stores the color determination threshold and the monochrome determination threshold; and an adjustment section that adjusts the color determination threshold and the monochrome determination threshold. The determination section accepts a determination instruction from a user, upon determining that a color level of the manuscript is within a threshold interval region between the color determination threshold and the monochrome determination threshold, both inclusive. The adjustment section adjusts the color determination threshold or the monochrome determination threshold, based on the determination instruction. The adjustment section changes the color determination threshold and the monochrome determination threshold to a color/monochrome determination threshold, when a difference between the color determination threshold and the monochrome determination threshold is less than or equal to a predetermined value.

The image processing method of the present disclosure includes reading a manuscript; using a color determination threshold and a monochrome determination threshold to determine whether the manuscript is a color manuscript or a monochrome manuscript, the monochrome determination threshold being different from the color determination threshold; accepting a determination instruction from a user, upon determining that a color level of the manuscript is within a threshold interval region between the color determination threshold and the monochrome determination threshold, both inclusive; adjusting the color determination threshold or the monochrome determination threshold, based on the determination instruction; and changing the color determination threshold and the monochrome determination threshold to a color/monochrome determination threshold, when a difference between the color determination threshold and the monochrome determination threshold is less than or equal to a predetermined value.

### BRIEF DESCRIPTION OF THE DRAWINGS

FIG. 1 is a diagram illustrating the external appearance configuration of a multifunction peripheral.

FIG. 2 is a diagram illustrating the schematic configuration of an image reading unit.

FIG. 3 is a diagram illustrating the block configuration of the multifunction peripheral.

FIG. 4 is a diagram illustrating an example of histogram data.

FIG. 5 is a diagram illustrating an example of a control flow executed by the multifunction peripheral.

FIG. 6 is a diagram illustrating an example of a determination value setting screen.

FIG. 7 is a diagram illustrating an example of a determination input screen.

FIG. 8 is a diagram illustrating an example of a method of determination value adjustment performed by the multifunction peripheral.

FIG. 9 is a diagram illustrating an example of the method of determination value adjustment performed by the multifunction peripheral.

FIG. 10 is a diagram illustrating an example of the method of determination value adjustment performed by the multifunction peripheral.

### DESCRIPTION OF EMBODIMENTS

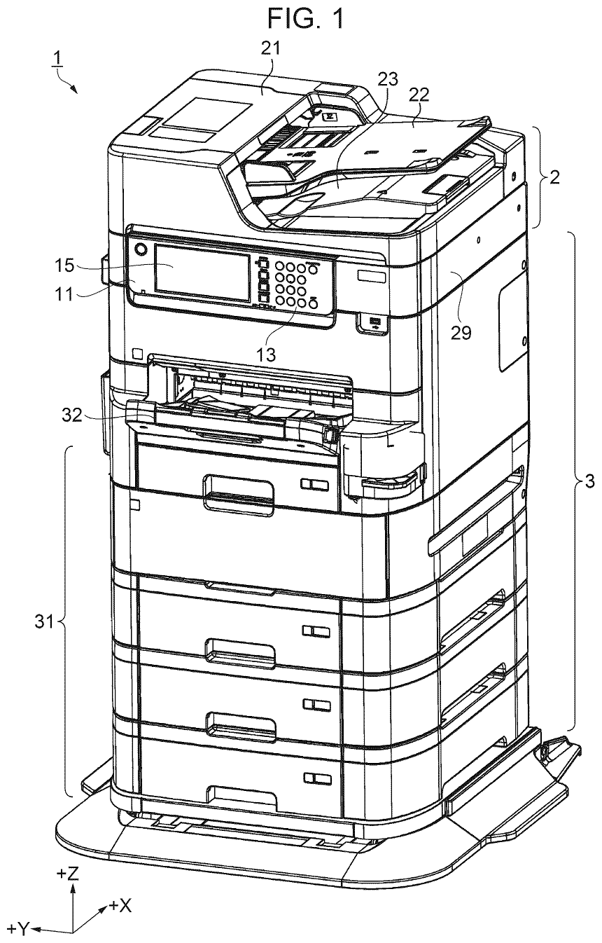

FIG. 1 illustrates the external appearance configuration of a multifunction peripheral 1. The multifunction peripheral 1 has a reading function of reading a manuscript M, a copying function of copying a manuscript, a printing function of printing print data, and the like. The multifunction peripheral 1 illustrated in FIG. 1 includes an image reading unit 2, a printing unit 3 that supports the image reading unit 2, and an input/output unit 11. The multifunction peripheral 1 corresponds to an example of an image processing apparatus.

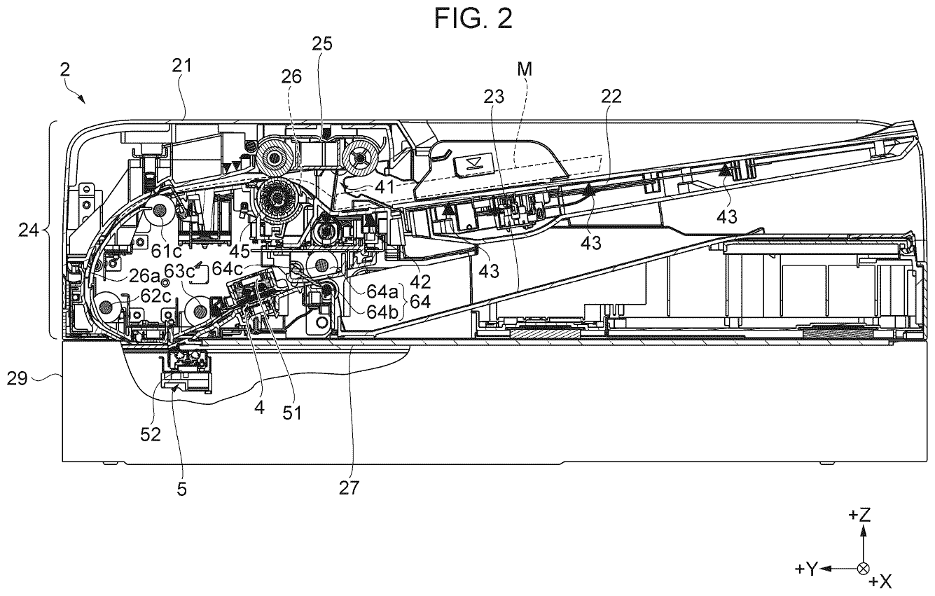

FIGS. 1 and 2 illustrate a three-dimensional coordinate system. A Z-axis is an axis perpendicular to the installation surface of the multifunction peripheral 1. A +Z direction is a direction from the installation surface toward the space above the multifunction peripheral 1. A −Z direction is a direction from the space above the multifunction peripheral 1 toward the installation surface. An X-axis is an axis perpendicular to a Y-axis and the Z-axis. A +X direction is a direction from the front surface to the rear surface when the housing surface of the multifunction peripheral 1, on which an input/output unit 11 to be described later is disposed, is defined as the front surface. A −X direction is a direction from the rear surface to the front surface of the multifunction peripheral 1. The Y-axis is an axis perpendicular to the X-axis and the Z-axis. A +Y direction is a direction from right to left in a plan view from the front surface of the multifunction peripheral 1. A −Y direction is a direction from left to right in the plan view from the front surface of the multifunction peripheral 1.

The image reading unit 2 reads the manuscript M and generates read data. The image reading unit 2 corresponds to an example of a scanning section. When reading a plurality of manuscripts M, the image reading unit 2 generates read data corresponding to each of the manuscripts M. The read data corresponds to an example of a read result. The image reading unit 2 includes a cover housing 21 and a support housing 29.

The cover housing 21 is disposed at a position in the +Z direction of the support housing 29. The cover housing 21 is openable and closable with respect to the support housing 29. The cover housing 21 includes a manuscript mounting section 22 and a manuscript discharge section 23.

On the manuscript mounting section 22, one or more manuscripts M are mounted. The one or more manuscripts M to be read by the image reading unit 2 are mounted on the manuscript mounting section 22. The one or more manuscripts M mounted on the manuscript mounting section 22 are transported to the inside of the image reading unit 2 one by one.

On the manuscript discharge section 23, a manuscript M read by the image reading unit 2 is mounted. The manuscript M discharged from the inside of the image reading unit 2 is mounted on the manuscript discharge section 23. The manuscript discharge section 23 is provided at a position in the-Z direction of the manuscript mounting section 22.

The printing unit 3 performs printing on a medium on the basis of read data or print data. The printing unit 3 corresponds to an example of a printing section. The printing unit 3 includes a medium accommodation section 31, a medium discharge section 32, and an image recording section 33 to be described later.

The medium accommodation section 31 accommodates a medium on which printing is to be performed by the printing unit 3. The medium accommodation section 31 is constituted by one or more paper feed cassettes. The multifunction peripheral 1 illustrated in FIG. 1 includes a plurality of paper feed cassettes. The medium accommodation section 31 is disposed at a position in the −Z direction of the printing unit 3.

On the medium discharge section 32, a medium on which printing has been performed by the printing unit 3 is mounted. On the medium discharge section 32, the medium discharged from the inside of the printing unit 3 is mounted. In the multifunction peripheral 1 illustrated in FIG. 1, the medium discharge section 32 is disposed on the front surface of the multifunction peripheral 1.

The input/output unit 11 outputs various kinds of information to an operator, and accepts various instructions and the like in accordance with an input operation by the operator. The operator corresponds to an example of a user. The input/output unit 11 illustrated in FIG. 1 is provided on the image reading unit 2, but is not limited thereto. The input/output unit 11 may be provided on the printing unit 3. The input/output unit 11 includes a plurality of operation buttons 13 and a display panel 15.

The operation buttons 13 accept an input operation by the operator. When the operator performs various input operations on the operation buttons 13, the input/output unit 11 accepts the various input operations and generates operation signals corresponding to the input operations.

The display panel 15 displays various screens for operating the image reading unit 2 and the printing unit 3. The display panel 15 displays a preview image based on read data generated when the manuscript M is read by the image reading unit 2. The display panel 15 is constituted by a liquid crystal display, an organic electroluminescent (EL) display, or the like. The display panel 15 may have a touch input function. The display panel 15 accepts various instructions in accordance with an input operation by the operator. The display panel 15 corresponds to an example of a display section.

FIG. 2 illustrates the schematic configuration of the image reading unit 2. FIG. 2 illustrates the image reading unit 2 in a sectional view from the −X direction. In FIG. 2, a manuscript M mounted on the manuscript mounting section 22 is indicated by a broken line. The cover housing 21 of the image reading unit 2 includes the manuscript mounting section 22, a transport section 24, a first sensor unit 4, a first elastic member 51, and the manuscript discharge section 23. The support housing 29 of the image reading unit 2 includes a second sensor unit 5, a second elastic member 52, and a manuscript table 27.

The manuscript mounting section 22 is provided with a regulation unit 41, a mounting detector 42, and a size detector 43. The regulation unit 41 regulates feeding of the manuscript M mounted on the manuscript mounting section 22 in a transport direction. The mounting detector 42 detects the manuscript M mounted on the manuscript mounting section 22. The size detector 43 detects the size of the manuscript M mounted on the manuscript mounting section 22.

The transport section 24 transports the manuscript M mounted on the manuscript mounting section 22 toward the manuscript discharge section 23. The transport section 24 includes a feeding unit 25, a transport path 26, a plurality of rollers, and a discharge roller pair 64.

The feeding unit 25 separates and feeds the manuscript M one by one from manuscripts M stacked on the manuscript mounting section 22. The feeding unit 25 includes a retard roller 45 and the like for separating the stacked manuscripts M.

The transport path 26 is a path through which the manuscript M passes inside the image reading unit 2. The transport path 26 connects the manuscript mounting section 22 to the manuscript discharge section 23. The transport path 26 includes a curved path 26a. The transport path 26 includes the curved path 26a to transport the manuscript M from the manuscript mounting section 22 to the manuscript discharge section 23, which is disposed at a position in the −Z direction of the manuscript mounting section 22.

The plurality of rollers are arranged along the transport path 26. The plurality of rollers support the manuscript M fed from the feeding unit 25. The plurality of rollers include a first roller 61c, a second roller 62c, a third roller 63c, and a fourth roller 64c. The first roller 61c, the second roller 62c, the third roller 63c, and the fourth roller 64c are sequentially arranged from the manuscript mounting section 22 toward the manuscript discharge section 23.

The discharge roller pair 64 discharges the manuscript M transported in the transport path 26 to the manuscript discharge section 23. The discharge roller pair 64 includes a first discharge roller 64a and a second discharge roller 64b. One of the first discharge roller 64a and the second discharge roller 64b is rotationally driven by a drive source (not illustrated).

The first sensor unit 4 and the second sensor unit 5 are disposed along the transport path 26.

The first sensor unit 4 reads an image on a first surface of the manuscript M transported in the transport path 26 from the +Z direction. The first sensor unit 4 includes a contact image sensor module (not illustrated). The contact image sensor module is a module into which a light-receiving element, a light source, and a lens array are integrated.

The first elastic member 51 presses the first sensor unit 4 against the transport path 26. The first elastic member 51 presses the first sensor unit 4 against the transport path 26 and holds the first sensor unit 4 at a predetermined position. The first elastic member 51 keeps a predetermined distance between the first sensor unit 4 and the manuscript M transported in the transport path 26.

The second sensor unit 5 reads an image on a second surface of the manuscript M transported in the transport path 26 from the −Z direction via the manuscript table 27. The second surface of the manuscript M is a surface opposite to the first surface of the manuscript M. The second sensor unit 5 includes a contact image sensor module (not illustrated) similarly to the first sensor unit 4. The contact image sensor module included in the second sensor unit 5 may have the same configuration as the contact image sensor module included in the first sensor unit 4, or may have a different configuration. The second sensor unit 5 can be moved in the +Y direction or the −Y direction along the manuscript table 27 by a moving section (not illustrated).

The second elastic member 52 presses the second sensor unit 5 against the manuscript table 27. The second elastic member 52 presses the second sensor unit 5 against the manuscript table 27 and holds the second sensor unit 5 at a predetermined position. The second elastic member 52 keeps a predetermined distance between the second sensor unit 5 and the manuscript M.

The manuscript M can be mounted on the manuscript table 27. The manuscript table 27 has a light-transmitting property. The manuscript table 27 is constituted by, for example, glass capable of transmitting light. The manuscript table 27 supports the second surface of the manuscript M transported along the transport path 26.

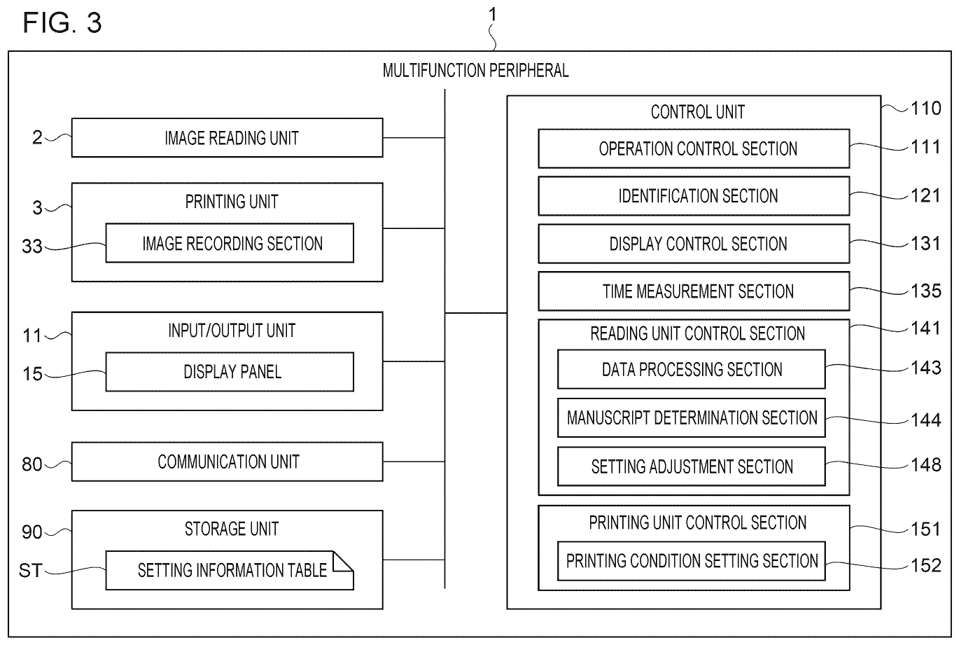

FIG. 3 illustrates the block configuration of the multifunction peripheral 1. The multifunction peripheral 1 includes the image reading unit 2, the printing unit 3, the input/output unit 11, a communication unit 80, a storage unit 90, and a control unit 110.

The image reading unit 2 reads the manuscript M and generates read data under the control of the control unit 110. The image reading unit 2 transmits the read data to the control unit 110. The image reading unit 2 may transmit the read data to the printing unit 3, the input/output unit 11, the communication unit 80, and the storage unit 90.

The printing unit 3 performs printing under the control of the control unit 110. The printing unit 3 copies the manuscript M based on the read data transmitted from the control unit 110 or the like. The printing unit 3 performs printing based on print data received via the communication unit 80. The printing unit 3 performs monochrome printing or color printing based on the read data or the like. In monochrome printing, an image is printed on a medium with black ink. In color printing, an image is printed on a medium with inks of multiple colors. The printing unit 3 includes the image recording section 33.

The image recording section 33 is a mechanism that prints an image on a medium using an ink of one color or inks of multiple colors. The image recording section 33 is, for example, an ink jet head that prints an image by ejecting ink onto a medium. The ink jet head is capable of ejecting inks of multiple colors onto a medium.

The input/output unit 11 transmits various operation signals generated in accordance with an input operation of the operator to the control unit 110. The input/output unit 11 transmits various instructions from the operator to the control unit 110 by transmitting an operation signal to the control unit 110. The input/output unit 11 operates various units such as the image reading unit 2 by transmitting an operation signal to the control unit 110. The input/output unit 11 includes the display panel 15.

The display panel 15 displays various screens and the like under the control of the control unit 110. The display panel 15 displays a menu screen for operating various units. The display panel 15 displays a setting screen for performing various settings. The display panel 15 displays read data transmitted from the image reading unit 2 or the like as a preview image. The display panel 15 may display, as a preview image, read data corrected on the basis of reading settings set on the setting screen.

The communication unit 80 is an interface circuit that communicates with an external device. The communication unit 80 is connected to the external device in a wired or wireless manner in accordance with a predetermined communication protocol. The communication unit 80 includes a wired connector, wireless communication port, or the like. The wired connector is a universal serial bus (USB) connector or the like. The wireless communication port is a Bluetooth communication port or the like. Bluetooth is a registered trademark. The communication unit 80 receives print data, various setting data, and the like from the external device. The communication unit 80 transmits read data read by the image reading unit 2, an operation result of each unit, and the like to the external device.

The storage unit 90 stores various programs and various data. The storage unit 90 is constituted by a semiconductor memory such as a read-only memory (ROM) or a random-access memory (RAM). The storage unit 90 may include a hard disk drive (HDD). The storage unit 90 stores read data, print data, a color determination value Lc, a monochrome determination value Lm, and the like. The color determination value Lc and the monochrome determination value Lm will be described later. The storage unit 90 stores a setting information table ST. The storage unit 90 corresponds to an example of a storage section.

The setting information table ST is a storage table that stores various setting information in association with the operator. The setting information table ST includes, for example, operator identification information, the color determination value Lc, the monochrome determination value Lm, a reading mode setting, a print color setting, and the like. The operator identification information is information for identifying the operator of the multifunction peripheral 1. The reading mode setting is a reading setting when the operator causes the image reading unit 2 to read the manuscript M. The print color setting is a color/monochrome setting when the operator causes the printing unit 3 to perform printing. The setting information table ST may include information related to a single-sided/double-sided printing setting or the like.

The storage unit 90 may store a plurality of divisional determination values Ld. The divisional determination values Ld include a first divisional determination value Ld1, a second divisional determination value Ld2, and a third divisional determination value Ld3, and the like. The divisional determination values Ld including the first divisional determination value Ld1, the second divisional determination value Ld2, and the third divisional determination value Ld3, and the like will be described later. The divisional determination values Ld may be stored in the setting information table ST in association with the operator. The divisional determination values Ld are calculated using the color determination value Lc and the monochrome determination value Lm.

The control unit 110 is a controller that controls the multifunction peripheral 1. The control unit 110 is, for example, a processor including a central processing unit (CPU). The control unit 110 includes one or more processors. The control unit 110 functions as an operation control section 111, an identification section 121, a display control section 131, a time measurement section 135, a reading unit control section 141, and a printing unit control section 151 by executing a control program. The control unit 110 may function as a functional unit other than the operation control section 111, the identification section 121, the display control section 131, the time measurement section 135, the reading unit control section 141, and the printing unit control section 151.

The operation control section 111 causes the multifunction peripheral 1 to operate as any one of a reading apparatus, a copying apparatus, and a printing apparatus. When the operator performs a predetermined input operation on the menu screen displayed on the display panel 15, the input/output unit 11 generates a function designation signal for designating the function of the multifunction peripheral 1. The input/output unit 11 transmits the function designation signal to the control unit 110. The operation control section 111 of the control unit 110 receives the function designation signal. On the basis of the function designation signal, the operation control section 111 causes the multifunction peripheral 1 to operate as any one of a reading apparatus, a copying apparatus, and a printing apparatus. When the multifunction peripheral 1 has a facsimile function, the operation control section 111 may cause the multifunction peripheral 1 to operate as a facsimile apparatus.

The identification section 121 identifies the operator of the multifunction peripheral 1. When the operator inputs identification information for identifying an individual with the input/output unit 11 as an example, the input/output unit 11 generates an identification signal. The input/output unit 11 transmits the identification signal to the control unit 110. The identification section 121 of the control unit 110 acquires the identification signal. The identification section 121 specifies the operator identification information corresponding to the identification signal. When the multifunction peripheral 1 includes a card reader that reads a personal card of the operator, the identification section 121 may receive an identification signal read by the card reader and specify the operator identification information.

The display control section 131 controls a screen, an image, and the like displayed on the display panel 15. The display control section 131 causes the display panel 15 to display the menu screen, a determination input screen 400 to be described later, various setting screens, and the like. The display control section 131 causes the display panel 15 to display read data as a preview image. The display control section 131 may cause the display panel 15 to display read data corrected on the basis of the reading settings as a preview image. The display control section 131 corresponds to an example of a display screen control section.

The time measurement section 135 measures an elapsed time and outputs elapsed time information related to the elapsed time. The time measurement section 135 measures the elapsed time using, as a trigger, a control signal output from the operation control section 111, the identification section 121, the display control section 131, or the like. For example, the time measurement section 135 uses a display signal output from the display control section 131 as a trigger to measure the elapsed time after the display signal is output, and outputs elapsed time information to the reading unit control section 141 and the like. The time measurement section 135 corresponds to an example of a timing section.

The reading unit control section 141 controls the image reading unit 2. The reading unit control section 141 controls various operations of the image reading unit 2, processing of read data, various settings, and the like. The reading unit control section 141 functions as a data processing section 143, a manuscript determination section 144, and a setting adjustment section 148.

The data processing section 143 acquires read data transmitted from the image reading unit 2 and performs data processing. For example, the data processing section 143 generates histogram data using the read data. The data processing section 143 calculates color data CD such as saturation and brightness for each manuscript M on the basis of the histogram data. The color data CD is data indicating the color degree of each manuscript M. The color data CD corresponds to an example of a color level. The data processing section 143 transmits the color data CD to the manuscript determination section 144, the setting adjustment section 148, and the like. The data processing section 143 may store the color data CD of each manuscript M in the storage unit 90.

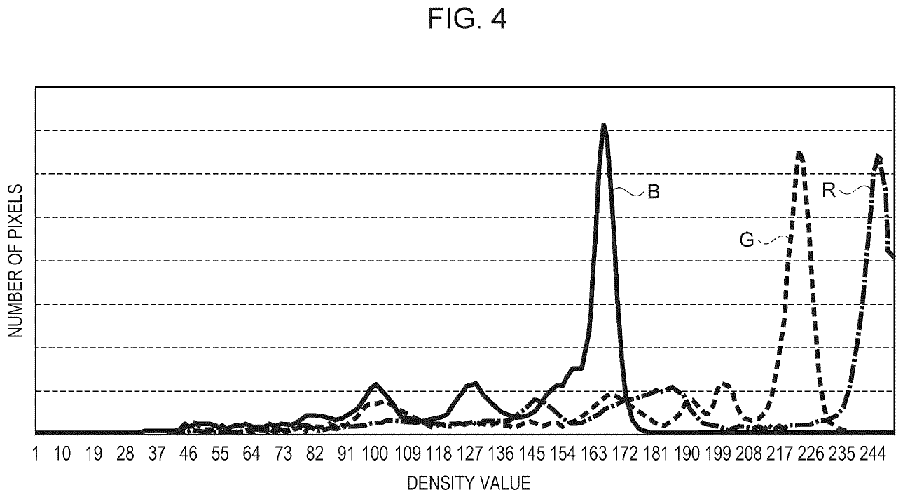

FIG. 4 illustrates an example of the histogram data. FIG. 4 illustrates the histogram data of a manuscript M. The histogram data includes the number of pixels for each gradation value of each color of red, green, and blue. The histogram data varies depending on the color of an image included in the manuscript M. The data processing section 143 calculates color data CD such as saturation and brightness for each manuscript M on the basis of histogram data as illustrated in FIG. 4.

The manuscript determination section 144 illustrated in FIG. 3 determines whether a manuscript M read by the image reading unit 2 is a color manuscript or a monochrome manuscript. The manuscript determination section 144 corresponds to an example of a determination section. The manuscript determination section 144 acquires read data corresponding to the manuscript M read by the image reading unit 2. The manuscript determination section 144 uses the color determination value Lc and the monochrome determination value Lm to determine whether the manuscript M is a color manuscript or a monochrome manuscript.

The color determination value Lc is a determination value for determining whether the read data is a color image. The color determination value Lc corresponds to an example of a color determination threshold. The color determination value Lc is stored in advance in the setting information table ST in association with the operator identification information. The color determination value Lc is adjusted by the setting adjustment section 148.

The monochrome determination value Lm is a determination value for determining whether the read data is a monochrome image. The monochrome determination value Lm corresponds to an example of a monochrome determination threshold. The monochrome determination value Lm is different from the color determination value Lc, and is less than the color determination value Lc. The monochrome determination value Lm is stored in advance in the setting information table ST in association with the operator identification information. The monochrome determination value Lm is adjusted by the setting adjustment section 148.

The manuscript determination section 144 acquires the operator identification information identified in advance by the identification section 121. The manuscript determination section 144 reads, from the storage unit 90, the color determination value Lc and the monochrome determination value Lm associated with the operator identification information in the setting information table ST. The manuscript determination section 144 compares the color determination value Lc and the monochrome determination value Lm with the color data CD. When the color data CD is greater than the color determination value Lc, the manuscript determination section 144 determines that the manuscript M is a color manuscript. When the color data CD is less than the monochrome determination value Lm, the manuscript determination section 144 determines that the manuscript M is a monochrome manuscript.

When the color data CD is less than or equal to the color determination value Lc and greater than or equal to the monochrome determination value Lm, the manuscript determination section 144 determines that the color data CD is within a determination value interval region LA. The determination value interval region LA is a region between the color determination value Lc and the monochrome determination value Lm, both inclusive. The determination value interval region LA corresponds to an example of a threshold interval region. The manuscript determination section 144 transmits in-range information indicating that the color data CD is within the determination value interval region LA to the display control section 131 and the setting adjustment section 148. Upon receiving the in-range information, the display control section 131 causes the display panel 15 to display the determination input screen 400. Upon receiving the in-range information, the setting adjustment section 148 adjusts the color determination value Lc or the monochrome determination value Lm.

Upon receiving an operator instruction signal, the manuscript determination section 144 determines whether the color data CD indicates a color manuscript or a monochrome manuscript on the basis of the operator instruction signal. The operator instruction signal is a signal generated by the input/output unit 11 when the operator performs a selection instruction on the determination input screen 400. The selection instruction corresponds to an example of a determination instruction. The manuscript determination section 144 accepts the selection instruction from the operator by receiving the operator instruction signal.

After transmitting the in-range information to the display control section 131, the manuscript determination section 144 acquires the display time of the determination input screen 400 from the time measurement section 135. The display time is an elapsed time from when the display panel 15 displays the determination input screen 400 under the control of the display control section 131. The display time is measured by the time measurement section 135. The display time corresponds to an example of a display elapsed time.

The manuscript determination section 144 determines whether the display time exceeds an input waiting time before accepting the selection instruction. The input waiting time is predetermined and stored in the storage unit 90. The input waiting time corresponds to an example of a waiting time. Upon accepting the selection instruction before the display time reaches the input waiting time, the manuscript determination section 144 determines whether the manuscript M is a color manuscript or a monochrome manuscript on the basis of the selection instruction. Upon determining that the display time exceeds the input waiting time before accepting the selection instruction, the manuscript determination section 144 compares the color data CD with the color determination value Lc and the monochrome determination value Lm, and determines whether the manuscript M is a color manuscript or a monochrome manuscript.

The manuscript determination section 144 compares the color data CD with the color determination value Lc and the monochrome determination value Lm. Upon determining that the color data CD is closer to the color determination value Lc than to the monochrome determination value Lm, the manuscript determination section 144 determines that the manuscript M is a color manuscript. Upon determining that the color data CD is closer to the monochrome determination value Lm than to the color determination value Lc, the manuscript determination section 144 determines that the manuscript M is a monochrome manuscript.

When the storage unit 90 stores the divisional determination values Ld, the manuscript determination section 144 may determine whether the manuscript M is a color manuscript or a monochrome manuscript by comparing the color data CD with the divisional determination values Ld. A method of determining the manuscript M using the divisional determination values Ld will be described later.

The setting adjustment section 148 adjusts the color determination value Lc and the monochrome determination value Lm. The setting adjustment section 148 corresponds to an example of an adjustment section. The setting adjustment section 148 acquires the color data CD for each manuscript M calculated by the data processing section 143. The setting adjustment section 148 adjusts the color determination value Lc and the monochrome determination value Lm on the basis of the color data CD.

The setting adjustment section 148 generates a color/monochrome determination value LI. The color/monochrome determination value LI corresponds to an example of a color/monochrome determination threshold. The setting adjustment section 148 generates the color/monochrome determination value LI by changing the color determination value Lc and the monochrome determination value Lm to the color/monochrome determination value LI. The color/monochrome determination value LI is one determination value used to determine whether the manuscript M is a color manuscript or a monochrome manuscript. When the color/monochrome determination value LI is generated, the determination value interval region LA is not set.

For example, after adjusting the color determination value Lc, the setting adjustment section 148 calculates the difference between the adjusted color determination value Lc and the monochrome determination value Lm as a difference value. The setting adjustment section 148 compares the difference value with a difference threshold Th. The difference threshold Th is predetermined and stored in the storage unit 90. The difference threshold Th corresponds to an example of a predetermined value. When the difference value is less than the difference threshold Th, the setting adjustment section 148 changes the color determination value Lc and the monochrome determination value Lm to the color/monochrome determination value LI. After adjusting the monochrome determination value Lm, the setting adjustment section 148 calculates the difference between the adjusted monochrome determination value Lm and the color determination value Lc as a difference value. When the difference value is less than the difference threshold Th, the setting adjustment section 148 changes the color determination value Lc and the monochrome determination value Lm to the color/monochrome determination value LI.

The printing unit control section 151 controls the printing unit 3. The printing unit control section 151 copies the manuscript M by causing the image recording section 33 to print read data. The printing unit control section 151 causes the image recording section 33 to execute color printing or monochrome printing by controlling the operation of the image recording section 33. The printing unit control section 151 includes a printing condition setting section 152.

The printing condition setting section 152 performs printing settings of the printing unit 3. The printing condition setting section 152 corresponds to an example of a printing setting section. The printing settings include a color printing setting, a monochrome printing setting, and an automatic printing setting. The printing settings may include a double-sided printing setting, a single-sided printing setting, and the like. When the operator performs an input operation related to the printing settings on the input/output unit 11, the input/output unit 11 generates a printing setting signal related to the printing settings. The input/output unit 11 transmits the printing setting signal to the control unit 110. The printing condition setting section 152 acquires the printing setting signal and selects the color printing setting or the like on the basis of the printing setting signal. The printing condition setting section 152 selects one of the color printing setting, the monochrome printing setting, and the automatic printing setting on the basis of the printing setting signal, and sets the selected printing setting. The printing condition setting section 152 operates the printing unit 3 with the selected printing setting. When the printing setting is set, the printing condition setting section 152 may transmit printing setting information indicating the set printing setting to the setting adjustment section 148.

The color printing setting is a setting for causing the printing unit 3 to execute color printing. The monochrome printing setting is a setting for causing the printing unit 3 to execute monochrome printing. The automatic printing setting is a setting for determining whether the print data or the read data is data for printing a color image or data for printing a monochrome image, and executing printing with the determined data type.

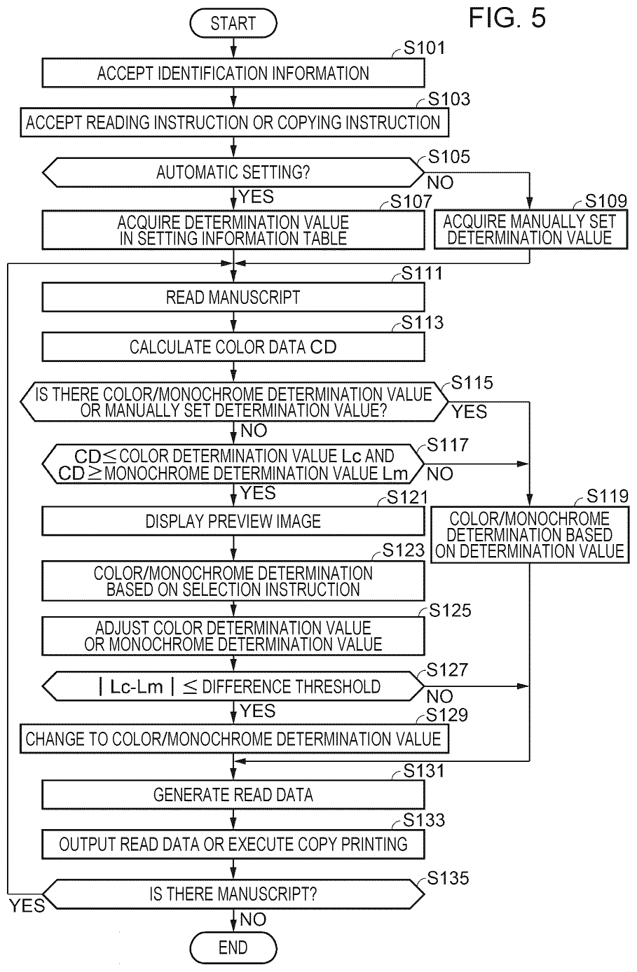

FIG. 5 illustrates an example of a control flow executed by the multifunction peripheral 1. FIG. 5 illustrates the example of the control flow executed by the multifunction peripheral 1 with a flowchart. The control flow corresponds to an example of an image processing method. FIG. 5 illustrates a control flow for generating the color/monochrome determination value LI. The operator operates the image reading unit 2 and causes the image reading unit 2 to read a manuscript M. The image reading unit 2 may read one manuscript M or may read two or more manuscripts M. The image reading unit 2 reads a manuscript M and generates read data. The image reading unit 2 transmits the read data to the control unit 110. The control unit 110 receives the read data, and changes the color determination value Lc and monochrome determination value Lm to the color/monochrome determination value LI on the basis of the read data.

In step S101, the multifunction peripheral 1 accepts the identification information of the operator. The operator inputs the identification information for identifying the operator by using the input/output unit 11. When the identification information is input, the input/output unit 11 generates an identification signal corresponding to the identification information. The input/output unit 11 transmits the identification signal to the control unit 110. The identification section 121 of the control unit 110 acquires the identification signal. The identification section 121 reads the setting information table ST stored in the storage unit 90. The identification section 121 specifies the operator identification information corresponding to the identification signal. The identification section 121 acquires the determination value including the color determination value Lc and the monochrome determination value Lm corresponding to the operator identification information from the setting information table ST, and transmits the acquired determination value to the manuscript determination section 144 and the setting adjustment section 148. The manuscript determination section 144 and the setting adjustment section 148 acquire the determination value.

After accepting the identification information of the operator, the multifunction peripheral 1 accepts a reading instruction or a copying instruction in step S103. When the operator performs a predetermined input operation on the input/output unit 11, the input/output unit 11 accepts the reading instruction or the copying instruction. The reading instruction is an instruction to output, to an external device or the storage unit 90, read data generated by causing the image reading unit 2 to read the manuscript M. The copying instruction is an instruction to cause the printing unit 3 to print read data generated by causing the image reading unit 2 to read the manuscript M.

After accepting the reading instruction or the copying instruction, the multifunction peripheral 1 determines whether the determination value setting is an automatic setting in step S105. The determination value setting related to the determination value is set in advance on a determination value setting screen 300. Before causing the image reading unit 2 to execute a reading operation, the operator performs an input operation on the determination value setting screen 300 to set the determination value setting. The determination value setting set on the determination value setting screen 300 is stored in the storage unit 90.

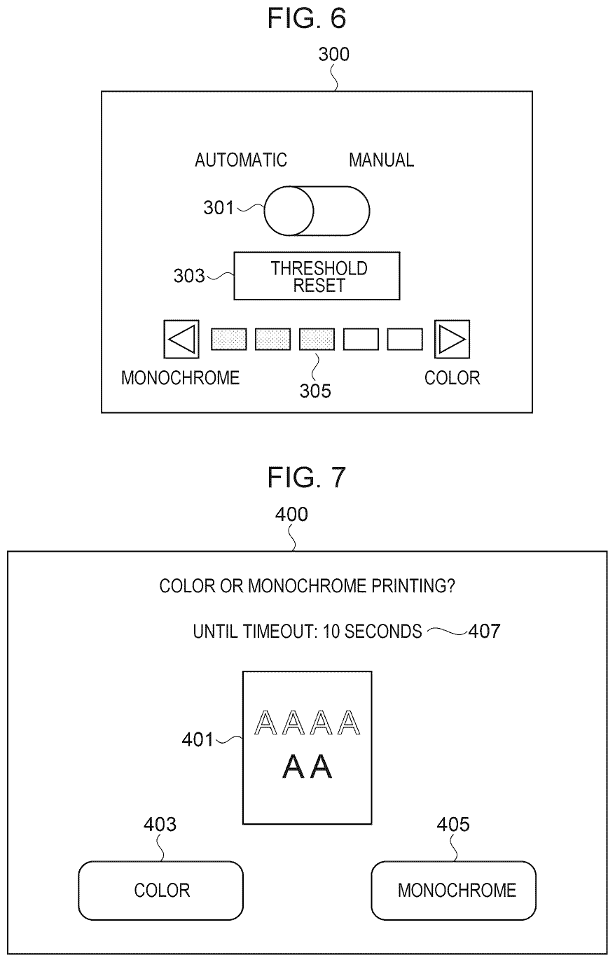

FIG. 6 illustrates an example of the determination value setting screen 300. The determination value setting screen 300 is displayed on the display panel 15. When the operator performs a predetermined input operation on the input/output unit 11, the determination value setting screen 300 is displayed on the display panel 15.

The determination value setting screen 300 accepts the determination value setting. When the operator performs an input operation on the determination value setting screen 300, the determination value setting screen 300 accepts the determination value setting. The determination value setting screen 300 includes a determination value setting switch button 301, a determination value reset button 303, and a manually set value input section 305.

The determination value setting switch button 301 accepts an input operation for switching the determination value setting to one of an automatic determination value setting and a manual determination value setting. When the operator performs an input operation on the determination value setting switch button 301, the image reading unit 2 is set to the automatic determination value setting or the manual determination value setting. The set determination value setting is stored in the storage unit 90 in association with the operator identification information. The determination value setting switch button 301 indicates the determination value setting selected by the input operation of the operator. The determination value setting switch button 301 illustrated in FIG. 6 indicates that the automatic determination value setting is selected as the determination value setting.

The automatic determination value setting is a setting in which the determination value stored in the setting information table ST is used for color/monochrome determination. The color/monochrome determination is to determine whether the manuscript M is a color manuscript or a monochrome manuscript. The determination value includes the color determination value Lc and the monochrome determination value Lm. The color determination value Lc stored in the setting information table ST is either the initial color determination value Lc stored in advance in the setting information table ST, or the color determination value Lc adjusted by the setting adjustment section 148. The monochrome determination value Lm stored in the setting information table ST is either the initial monochrome determination value Lm stored in advance in the setting information table ST, or the monochrome determination value Lm adjusted by the setting adjustment section 148. When the color determination value Lc and the monochrome determination value Lm have been changed to the color/monochrome determination value LI, the determination value stored in the setting information table ST is the color/monochrome determination value LI.

The manual determination value setting is a setting in which a manually set determination value set on the determination value setting screen 300 is used for the color/monochrome determination. The manually set determination value is set by the manually set value input section 305. The manually set determination value may include a manually set color determination value and a manually set monochrome determination value, or may be a manually set color/monochrome determination value.

The determination value reset button 303 accepts an input operation for resetting the determination value. In the determination value reset button 303 illustrated in FIG. 6, the determination value is displayed as a threshold. When the operator performs an input operation on the determination value reset button 303 while the determination value setting switch button 301 is indicating the automatic determination value setting, the determination value stored in the setting information table ST is changed to the initial color determination value Lc and the initial monochrome determination value Lm. When the operator performs an input operation on the determination value reset button 303 while the determination value setting switch button 301 is indicating the manual determination value setting, the manually set determination value is changed to the initial value.

The manually set value input section 305 accepts an input operation by the operator. When the operator performs an input operation on the manually set value input section 305, the manually set value input section 305 accepts a change of the manually set determination value. The manually set determination value is set by the operator performing an input operation on the manually set value input section 305. The set manually set determination value is stored in the storage unit 90 in association with the operator identification information.

In step S105 of the control flow illustrated in FIG. 5, the multifunction peripheral 1 reads the determination value setting stored in the storage unit 90, and determines the determination value setting. Upon determining that the determination value setting is the automatic determination value setting, the multifunction peripheral 1 proceeds to step S107 (step S105: YES). Upon determining that the determination value setting is not the automatic determination value setting but the manual determination value setting, the multifunction peripheral 1 proceeds to step S109 (step S105: NO).

In step S107, the multifunction peripheral 1 acquires the determination value stored in the setting information table ST. The manuscript determination section 144 of the reading unit control section 141 acquires the determination value stored in the setting information table ST. The determination value stored in the setting information table ST is either the color determination value Lc and the monochrome determination value Lm, or the color/monochrome determination value LI. After acquiring the determination value, the multifunction peripheral 1 proceeds to step S111.

In step S109, the multifunction peripheral 1 acquires the manually set determination value. The manuscript determination section 144 of the reading unit control section 141 acquires the manually set determination value stored in the storage unit 90 as the determination value. After acquiring the determination value, the multifunction peripheral 1 proceeds to step S111.

After acquiring the determination value, the multifunction peripheral 1 reads a manuscript M in step S111. The image reading unit 2 reads the manuscript M mounted on the manuscript mounting section 22 or the manuscript table 27 and generates read data. The image reading unit 2 transmits the read data to the control unit 110. The data processing section 143 of the control unit 110 acquires the read data.

After reading the manuscript M, the multifunction peripheral 1 calculates color data CD in step S113. The data processing section 143 generates histogram data using the read data. The data processing section 143 calculates the color data CD, such as saturation and brightness corresponding to the manuscript M, on the basis of the histogram data. The data processing section 143 transmits the color data CD to the manuscript determination section 144 and the setting adjustment section 148.

After calculating the color data CD, the multifunction peripheral 1 determines whether the determination value is the color/monochrome determination value LI or the manually set determination value in step S115. The manuscript determination section 144 determines whether the acquired determination value is the color/monochrome determination value LI or the manually set determination value. When the manuscript determination section 144 determines that the determination value is neither the color/monochrome determination value LI nor the manually set determination value, the multifunction peripheral 1 proceeds to step S117 (step S115: NO). When the manuscript determination section 144 determines that the determination value is the color/monochrome determination value LI or the manually set determination value, the multifunction peripheral 1 proceeds to step S119 (step S115: YES).

In step S117, the multifunction peripheral 1 determines whether the color data CD is less than or equal to the color determination value Lc and greater than or equal to the monochrome determination value Lm. The manuscript determination section 144 determines whether the color data CD is within the determination value interval region LA that is less than or equal to the color determination value Lc and greater than or equal to the monochrome determination value Lm. When the manuscript determination section 144 determines that the color data CD is not within the determination value interval region LA, the multifunction peripheral 1 proceeds to step S119 (step S117: NO). When the manuscript determination section 144 determines that the color data CD is within the determination value interval region LA, the multifunction peripheral 1 proceeds to step S121 (step S117: YES).

In step S119, the multifunction peripheral 1 performs color/monochrome determination based on the determination value. Upon acquiring the color/monochrome determination value LI as the determination value, the manuscript determination section 144 performs color/monochrome determination using the color/monochrome determination value LI. Upon acquiring the manually set determination value as the determination value, the manuscript determination section 144 performs color/monochrome determination using the manually set determination value. The multifunction peripheral 1 transmits the determination result to the reading unit control section 141, and proceeds to step S131.

The multifunction peripheral 1 displays a preview image in step S121. The display control section 131 acquires the read data from the image reading unit 2. The display control section 131 transmits the read data to the display panel 15 and causes the display panel 15 to display the preview image based on the read data. The display control section 131 causes the display panel 15 to display the determination input screen 400 including the preview image. The display control section 131 prompts the operator to issue a selection instruction by causing the display panel 15 to display the determination input screen 400.

FIG. 7 illustrates an example of the determination input screen 400. The determination input screen 400 is displayed on the display panel 15 under the control of the display control section 131. The determination input screen 400 corresponds to an example of a determination instruction screen. The determination input screen 400 includes a thumbnail image 401, a color selection icon 403, a monochrome selection icon 405, and a timeout time 407.

The thumbnail image 401 corresponds to the preview image based on the read data. The thumbnail image 401 is a display image obtained by reducing the manuscript M. The preview image is displayed in the form of the thumbnail image 401. The thumbnail image 401 may be a color image or a monochrome image. As an example, the thumbnail image 401 is displayed as a color image or a monochrome image in accordance with the reading settings.

The determination input screen 400 illustrated in FIG. 7 displays the thumbnail image 401 indicating the preview image, but is not limited to this. The determination input screen 400 does not necessarily display the thumbnail image 401. The determination input screen 400 preferably displays the thumbnail image 401. Displaying the thumbnail image 401 allows the operator to easily issue a selection instruction.

The color selection icon 403 is an icon on which the operator performs an input operation to specify that the manuscript M is a color manuscript. The operator performs an input operation on the color selection icon 403 directly or by using a predetermined one of the operation buttons 13. When the operator performs an input operation on the color selection icon 403, the input/output unit 11 transmits a selection instruction to select a color manuscript to the control unit 110. The manuscript determination section 144 accepts the selection instruction to select a color manuscript.

The monochrome selection icon 405 is an icon on which the operator performs an input operation to specify that the manuscript M is a monochrome manuscript. The operator performs an input operation on the monochrome selection icon 405 directly or by using a predetermined one of the operation buttons 13. When the operator performs an input operation on the monochrome selection icon 405, the input/output unit 11 transmits a selection instruction to select a monochrome manuscript to the control unit 110. The manuscript determination section 144 accepts the selection instruction to select a monochrome manuscript.

The timeout time 407 indicates the remaining time from when the determination input screen 400 is displayed on the display panel 15 until the input waiting time is reached. The timeout time 407 is measured by the time measurement section 135. When the display time from when the determination input screen 400 is displayed on the display panel 15 reaches the input waiting time, the timeout time 407 becomes 0 seconds. When the timeout time 407 becomes 0 seconds, the determination input screen 400 does not accept an input operation on the color selection icon 403 and the monochrome selection icon 405. When the display time from when the determination input screen 400 is displayed on the display panel 15 reaches the input waiting time, the determination input screen 400 does not accept a selection instruction. By providing the timeout time 407, it is possible to prevent the multifunction peripheral 1 from being maintained in a waiting state for a predetermined time or longer.

The determination input screen 400 illustrated in FIG. 7 displays the timeout time 407, but is not limited to this. The determination input screen 400 may display the timeout time 407 and does not necessarily display the timeout time 407. The determination input screen 400 preferably displays the timeout time 407. Displaying the timeout time 407 allows the operator to easily input a selection instruction.

In the control flow illustrated in FIG. 5, after displaying the preview image, the multifunction peripheral 1 performs color/monochrome determination based on the selection instruction in step S123. Upon accepting the selection instruction to select a color manuscript, the manuscript determination section 144 determines that the manuscript M is a color manuscript. Upon accepting the selection instruction to select a monochrome manuscript, the manuscript determination section 144 determines that the manuscript M is a monochrome manuscript.

When the display time from when the determination input screen 400 is displayed on the display panel 15 reaches the input waiting time, the manuscript determination section 144 determines whether the manuscript is a color manuscript or a monochrome manuscript, using the color data CD, the color determination value Lc, and the monochrome determination value Lm. The manuscript determination section 144 compares the color data CD with the color determination value Lc and the monochrome determination value Lm. Upon determining that the color data CD is closer to the color determination value Lc than to the monochrome determination value Lm, the manuscript determination section 144 determines that the manuscript M is a color manuscript. Upon determining that the color data CD is closer to the monochrome determination value Lm than to the color determination value Lc, the manuscript determination section 144 determines that the manuscript M is a monochrome manuscript.

After performing color/monochrome determination based on the selection instruction, the multifunction peripheral 1 adjusts the color determination value Lc or the monochrome determination value Lm in step S125. The setting adjustment section 148 acquires the color data CD. The setting adjustment section 148 adjusts the color determination value Lc or the monochrome determination value Lm using the color data CD.

When the manuscript determination section 144 determines that the manuscript M is a color manuscript, the setting adjustment section 148 adjusts the color determination value Lc using the color data CD. The setting adjustment section 148 adjusts the color determination value Lc by, for example, replacing the color determination value Lc with the color data CD. The adjustment of the color determination value Lc is not limited to the replacement with the color data CD. The setting adjustment section 148 adjusts the color determination value Lc on the basis of a predetermined adjustment method. After adjusting the color determination value Lc, the setting adjustment section 148 stores the adjusted color determination value Lc in the setting information table ST.

When the manuscript determination section 144 determines that the manuscript M is a monochrome manuscript, the setting adjustment section 148 adjusts the monochrome determination value Lm using the color data CD. The setting adjustment section 148 adjusts the monochrome determination value Lm by, for example, replacing the monochrome determination value Lm with the color data CD. The adjustment of the monochrome determination value Lm is not limited to the replacement with the color data CD. The setting adjustment section 148 adjusts the monochrome determination value Lm on the basis of a predetermined adjustment method. The method of adjusting the monochrome determination value Lm may be the same as or different from the method of adjusting the color determination value Lc. The method of adjusting the monochrome determination value Lm is preferably the same as the method of adjusting the color determination value Lc. After adjusting the monochrome determination value Lm, the setting adjustment section 148 stores the adjusted monochrome determination value Lm in the setting information table ST.

After adjusting the color determination value Lc or the monochrome determination value Lm, the multifunction peripheral 1 determines whether the difference between the color determination value Lc and the monochrome determination value Lm is less than the difference threshold Th in step S127. When adjusting the color determination value Lc, the setting adjustment section 148 calculates the difference between the adjusted color determination value Lc and the monochrome determination value Lm stored in the setting information table ST as the difference value. When adjusting the monochrome determination value Lm, the setting adjustment section 148 calculates the difference between the adjusted monochrome determination value Lm and the color determination value Lc stored in the setting information table ST as the difference value. The setting adjustment section 148 compares the difference value with the difference threshold Th.

When the setting adjustment section 148 determines that the difference value is greater than the difference threshold Th, the setting adjustment section 148 does not change the color determination value Lc and the monochrome determination value Lm to the color/monochrome determination value LI. The multifunction peripheral 1 proceeds to step S131 (step S127: NO). When the setting adjustment section 148 determines that the difference value is less than or equal to the difference threshold Th, the multifunction peripheral 1 proceeds to step S129 (step S127: YES).

In step S129, the multifunction peripheral 1 changes the color determination value Lc and the monochrome determination value Lm to the color/monochrome determination value LI. When the difference value is less than or equal to the difference threshold Th, the setting adjustment section 148 changes the color determination value Lc and the monochrome determination value Lm to the color/monochrome determination value LI. The setting adjustment section 148 changes the color determination value Lc and the monochrome determination value Lm to the color/monochrome determination value LI. This makes it possible to reduce the number of times the operator is prompted to issue a selection instruction. This improves the operator's convenience. The multifunction peripheral 1 changes the color determination value Lc and the monochrome determination value Lm to the color/monochrome determination value LI, and then proceeds to step S131.

In step S131, the multifunction peripheral 1 generates read data. When the manuscript determination section 144 determines that the manuscript M is a color manuscript, the reading unit control section 141 generates read data of color data. When the manuscript determination section 144 determines that the manuscript M is a monochrome manuscript, the reading unit control section 141 generates read data of monochrome data.

After generating the read data, the multifunction peripheral 1 outputs the read data or executes copy printing in step S133. The control unit 110 of the multifunction peripheral 1 outputs the read data or executes copy printing on the basis of the determination result of the color/monochrome determination.

Upon accepting the reading instruction in step S103, the multifunction peripheral 1 outputs the read data. When the manuscript determination section 144 determines that the manuscript M is a color manuscript, the reading unit control section 141 outputs the read data of color data to an external device via the communication unit 80. When the manuscript determination section 144 determines that the manuscript M is a color manuscript, the reading unit control section 141 may output the read data of color data to the storage unit 90 and store it in the storage unit 90. When the manuscript determination section 144 determines that the manuscript M is a monochrome manuscript, the reading unit control section 141 outputs the read data of monochrome data to an external device via the communication unit 80. When the manuscript determination section 144 determines that the manuscript M is a monochrome manuscript, the reading unit control section 141 may output the read data of monochrome data to the storage unit 90 and store it in the storage unit 90.

Upon accepting the copying instruction in step S103, the multifunction peripheral 1 executes copy printing. When the manuscript determination section 144 determines that the manuscript M is a color manuscript, the printing unit control section 151 causes the printing unit 3 to execute printing based on the read data of color data. The printing unit 3 prints a color image on a medium. When the manuscript determination section 144 determines that the manuscript M is a monochrome manuscript, the printing unit control section 151 causes the printing unit 3 to execute printing based on the read data of monochrome data. The printing unit 3 prints a monochrome image on a medium.

After outputting the read data or executing copy printing, the multifunction peripheral 1 determines whether the manuscript M is on the manuscript mounting section 22 in step S135. When the image reading unit 2 determines that the manuscript M is mounted on the manuscript mounting section 22, the multifunction peripheral 1 returns to step S111 (step S135: YES). When the image reading unit 2 determines that no manuscript M is mounted on the manuscript mounting section 22, the multifunction peripheral 1 ends the control flow (step S135: NO).

FIG. 5 illustrates the control flow for adjusting the determination value for each read manuscript M, but the control flow is not limited to this. The multifunction peripheral 1 may read a plurality of manuscripts M and then adjust the color determination value Lc and the monochrome determination value Lm using a plurality of pieces of color data CD.

The multifunction peripheral 1 includes the image reading unit 2, which reads a manuscript M; the manuscript determination section 144, which uses the color determination value Lc and the monochrome determination value Lm to determine whether the manuscript M is a color manuscript or a monochrome manuscript, the monochrome determination value Lm being different from the color determination value Lc; the storage unit 90, which stores the color determination value Lc and the monochrome determination value Lm; and the setting adjustment section 148, which adjusts the color determination value Lc and the monochrome determination value Lm. Upon determining that the color data CD of the manuscript M is within the determination value interval region LA between the color determination value Lc and the monochrome determination value Lm, both inclusive, the manuscript determination section 144 accepts a selection instruction from the operator. The setting adjustment section 148 adjusts the color determination value Lc or the monochrome determination value Lm on the basis of the selection instruction. When the difference between the color determination value Lc and the monochrome determination value Lm is less than or equal to the predetermined difference threshold Th, the setting adjustment section 148 changes the color determination value Lc and the monochrome determination value Lm to the color/monochrome determination value LI.

The setting adjustment section 148 changes the color determination value Lc and the monochrome determination value Lm to the color/monochrome determination value LI. This makes it possible to reduce the number of times the operator is prompted to issue a selection instruction. This improves the operator's convenience.

The multifunction peripheral 1 includes the display control section 131, which displays the determination input screen 400 prompting a selection instruction to be issued; the display panel 15, which displays the determination input screen 400; and the time measurement section 135, which measures the display time from when the determination input screen 400 is displayed on the display panel 15. Upon determining that the display time exceeds the predetermined input waiting time, the manuscript determination section 144 does not accept a selection instruction from the operator.

By providing the timeout time 407, it is possible to prevent the multifunction peripheral 1 from being maintained in a waiting state for a predetermined time or longer.

It is preferable that the manuscript determination section 144 compare the color data CD of the manuscript M with the color determination value Lc and the monochrome determination value Lm upon determining that the display time exceeds the predetermined input waiting time before accepting a selection instruction from the operator, and the manuscript determination section 144 determine that the manuscript M is a color manuscript upon determining that the color data CD is closer to the color determination value Lc than to the monochrome determination value Lm, and determine that the manuscript M is a monochrome manuscript upon determining that the color data CD is closer to the monochrome determination value Lm than to the color determination value Lc.

The multifunction peripheral 1 can determine whether the manuscript M is a color manuscript or a monochrome manuscript when a selection instruction is not input.

After the setting adjustment section 148 changes the color determination value Lc and the monochrome determination value Lm to the color/monochrome determination value LI, the display control section 131 preferably does not cause the display panel 15 to display the determination input screen 400.

When the determination input screen 400 is not displayed, the operator can use the multifunction peripheral 1 without performing an unnecessary selection instruction.

In the control flow, the manuscript M is read, and it is determined whether the manuscript M is a color manuscript or a monochrome manuscript using the color determination value Lc and the monochrome determination value Lm, which is different from the color determination value Lc. When it is determined that the color data CD of the manuscript M is within the determination value interval region LA between the color determination value Lc and the monochrome determination value Lm, both inclusive, a selection instruction from the operator is accepted, and the color determination value Lc or the monochrome determination value Lm is adjusted on the basis of the selection instruction. When the difference between the color determination value Lc and the monochrome determination value Lm is less than or equal to the predetermined difference threshold Th, the color determination value Lc and the monochrome determination value Lm are changed to the color/monochrome determination value LI.

The setting adjustment section 148 changes the color determination value Lc and the monochrome determination value Lm to the color/monochrome determination value LI. This makes it possible to reduce the number of times the operator is prompted to issue a selection instruction. This improves the operator's convenience.

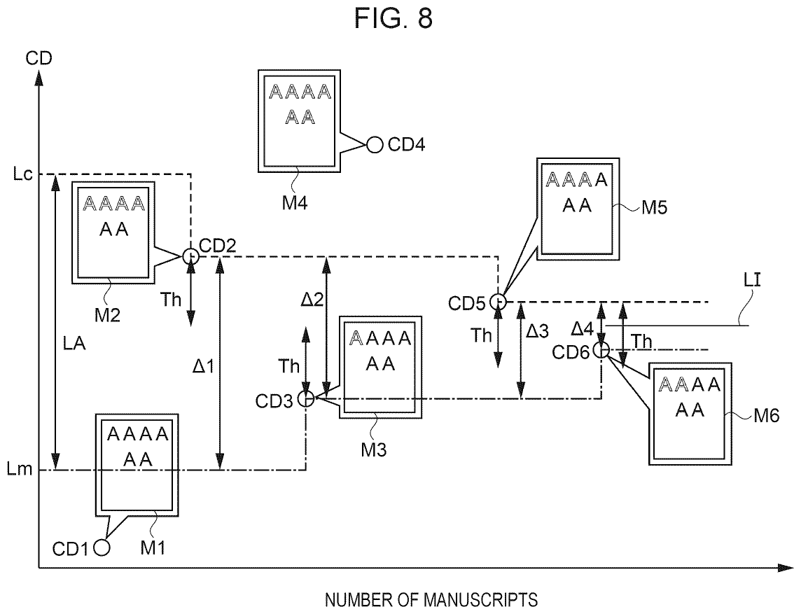

FIG. 8 illustrates an example of a method of determination value adjustment performed by the multifunction peripheral 1. FIG. 8 illustrates an adjustment example in which the color determination value Lc and monochrome determination value Lm are adjusted to the color/monochrome determination value LI. The horizontal axis of FIG. 8 indicates the number of manuscripts M read by the image reading unit 2. The vertical axis of FIG. 8 represents the color data CD. FIG. 8 illustrates an image example of each manuscript M, the color data CD of each manuscript M, a change of the color determination value Lc, a change of the monochrome determination value Lm, and the color/monochrome determination value LI. Each manuscript M is represented by an image example constituted by two types of characters. Of the two types of characters, bold characters represent color characters, and non-bold characters represent monochrome characters.

FIG. 8 illustrates an adjustment example in which six manuscripts M are read and the color determination value Lc and the monochrome determination value Lm are changed to the color/monochrome determination value LI. The six manuscripts M are a first manuscript M1, a second manuscript M2, a third manuscript M3, a fourth manuscript M4, a fifth manuscript M5, and a sixth manuscript M6 in the read order. Here, the color data CD of the first manuscript M1, the color data CD of the second manuscript M2, the color data CD of the third manuscript M3, the color data CD of the fourth manuscript M4, the color data CD of the fifth manuscript M5, and the color data CD of the sixth manuscript M6 are first color data CD1, second color data CD2, third color data CD3, fourth color data CD4, fifth color data CD5, and sixth color data CD6, respectively.

The first color data CD1 of the first manuscript M1 is compared with the color determination value Lc and the monochrome determination value Lm. The manuscript determination section 144 determines that the first color data CD1 is less than the monochrome determination value Lm and is not within the determination value interval region LA. The manuscript determination section 144 determines that the first manuscript M1 is a monochrome manuscript. The display control section 131 does not cause the display panel 15 to display the determination input screen 400. The setting adjustment section 148 does not adjust the monochrome determination value Lm.

The second color data CD2 of the second manuscript M2 is compared with the color determination value Lc and the monochrome determination value Lm. The manuscript determination section 144 determines that the second color data CD2 is within the determination value interval region LA. The display control section 131 causes the display panel 15 to display the determination input screen 400. The input/output unit 11 accepts a selection instruction to select a color manuscript. The manuscript determination section 144 determines that the second manuscript M2 is a color manuscript on the basis of the selection instruction to select a color manuscript. The setting adjustment section 148 adjusts the color determination value Lc. The setting adjustment section 148 sets the value of the second color data CD2 as the color determination value Lc. The adjusted color determination value Lc is the value of the second color data CD2.

After adjusting the color determination value Lc, the setting adjustment section 148 compares a first difference Δ1 between the adjusted color determination value Lc and the monochrome determination value Lm with the difference threshold Th. As illustrated in FIG. 8, the first difference Δ1 is greater than the difference threshold Th. The setting adjustment section 148 does not change the color determination value Lc and the monochrome determination value Lm to the color/monochrome determination value LI.

The third color data CD3 of the third manuscript M3 is compared with the adjusted color determination value Lc and the monochrome determination value Lm. The manuscript determination section 144 determines that the third color data CD3 is within the determination value interval region LA. The display control section 131 causes the display panel 15 to display the determination input screen 400. The input/output unit 11 accepts a selection instruction to select a monochrome manuscript. The manuscript determination section 144 determines that the third manuscript M3 is a monochrome manuscript on the basis of the selection instruction to select a monochrome manuscript. The setting adjustment section 148 adjusts the monochrome determination value Lm. The setting adjustment section 148 sets the value of the third color data CD3 as the monochrome determination value Lm. The adjusted monochrome determination value Lm is the value of the third color data CD3.

After adjusting the monochrome determination value Lm, the setting adjustment section 148 compares a second difference Δ2 between the adjusted color determination value Lc and the adjusted monochrome determination value Lm with the difference threshold Th. As illustrated in FIG. 8, the second difference Δ2 is greater than the difference threshold Th. The setting adjustment section 148 does not change the adjusted color determination value Lc and the adjusted monochrome determination value Lm to the color/monochrome determination value LI.

The fourth color data CD4 of the fourth manuscript M4 is compared with the adjusted color determination value Lc and the adjusted monochrome determination value Lm. The manuscript determination section 144 determines that the fourth color data CD4 is greater than the adjusted color determination value Lc and is not within the determination value interval region LA. The manuscript determination section 144 determines that the fourth manuscript M4 is a color manuscript. The display control section 131 does not cause the display panel 15 to display the determination input screen 400. The setting adjustment section 148 does not adjust the adjusted color determination value Lc.

The fifth color data CD5 of the fifth manuscript M5 is compared with the adjusted color determination value Lc and the adjusted monochrome determination value Lm. The manuscript determination section 144 determines that the fifth color data CD5 is within the determination value interval region LA. The display control section 131 causes the display panel 15 to display the determination input screen 400. The input/output unit 11 accepts a selection instruction to select a color manuscript. The manuscript determination section 144 determines that the fifth manuscript M5 is a color manuscript on the basis of the selection instruction to select a color manuscript. The setting adjustment section 148 adjusts the color determination value Lc. The setting adjustment section 148 sets the value of the fifth color data CD5 as the color determination value Lc. The adjusted color determination value Lc is the value of the fifth color data CD5.

After adjusting the color determination value Lc, the setting adjustment section 148 compares a third difference Δ3 between the color determination value Lc, which has been adjusted to the value of the fifth color data CD5, and the adjusted monochrome determination value Lm with the difference threshold Th. As illustrated in FIG. 8, the third difference Δ3 is greater than the difference threshold Th. The setting adjustment section 148 does not change the color determination value Lc, which has been adjusted to the value of the fifth color data CD5, and the adjusted monochrome determination value Lm to the color/monochrome determination value LI.

The sixth color data CD6 of the sixth manuscript M6 is compared with the color determination value Lc, which has been adjusted to the value of the fifth color data CD5, and the adjusted monochrome determination value Lm. The manuscript determination section 144 determines that the sixth color data CD6 is within the determination value interval region LA. The display control section 131 causes the display panel 15 to display the determination input screen 400. The input/output unit 11 accepts a selection instruction to select a monochrome manuscript. The manuscript determination section 144 determines that the sixth manuscript M6 is a monochrome manuscript on the basis of the selection instruction to select a monochrome manuscript. The setting adjustment section 148 adjusts the monochrome determination value Lm. The setting adjustment section 148 sets the value of the sixth color data CD6 as the monochrome determination value Lm. The adjusted monochrome determination value Lm is the value of the sixth color data CD6.

After adjusting the monochrome determination value Lm, the setting adjustment section 148 compares a fourth difference Δ4 between the color determination value Lc, which has been adjusted to the value of the fifth color data CD5, and the monochrome determination value Lm, which has been adjusted to the value of the sixth color data CD6, with the difference threshold Th. As illustrated in FIG. 8, the fourth difference Δ4 is less than the difference threshold Th. The setting adjustment section 148 changes the color determination value Lc, which has been adjusted to the value of the fifth color data CD5, and the monochrome determination value Lm, which has been adjusted to the value of the sixth color data CD6, to the color/monochrome determination value LI. The color/monochrome determination value LI is set to, for example, an intermediate value between the value of the fifth color data CD5 and the value of the sixth color data CD6. The color/monochrome determination value LI is not limited to an intermediate value between the value of the fifth color data CD5 and the value of the sixth color data CD6. The color/monochrome determination value LI may be any value between the value of the fifth color data CD5 and the value of the sixth color data CD6.

After the color determination value Lc and the monochrome determination value Lm are adjusted to the color/monochrome determination value LI, the manuscript determination section 144 determines whether the manuscript M is a color manuscript or a monochrome manuscript using the color/monochrome determination value LI. When the color/monochrome determination value LI is set, there is no determination value interval region LA, and the determination input screen 400 is not displayed. When the color/monochrome determination value LI is set, the multifunction peripheral 1 can perform color/monochrome determination without accepting a selection instruction. The operator can cause the multifunction peripheral 1 to execute desired color/monochrome determination without inputting a selection instruction.

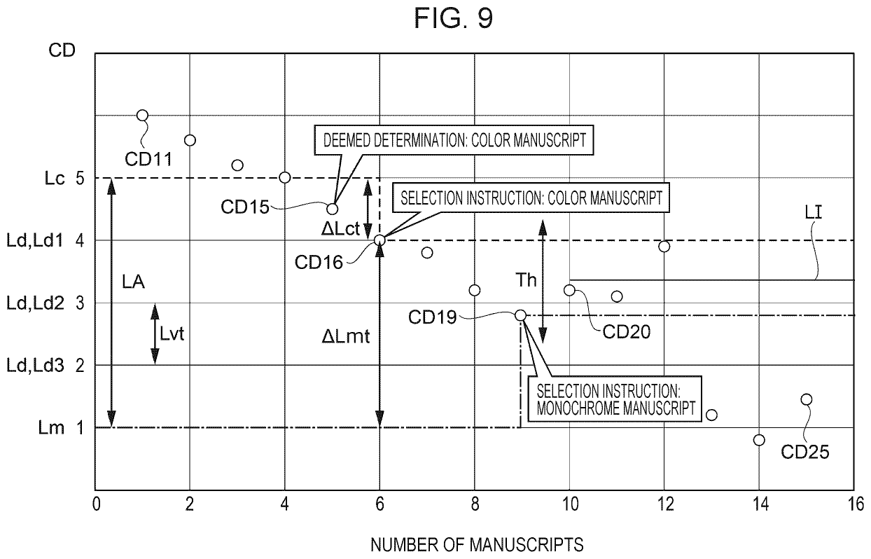

FIG. 9 illustrates an example of a method of determination value adjustment performed by the multifunction peripheral 1. FIG. 9 illustrates an adjustment example in which the color determination value Lc and monochrome determination value Lm are adjusted to the color/monochrome determination value LI. FIG. 9 illustrates an adjustment example different from the adjustment example illustrated in FIG. 8. The horizontal axis of FIG. 9 indicates the number of manuscripts M read by the image reading unit 2. The vertical axis of FIG. 9 represents the color data CD. FIG. 9 illustrates the color data CD of each manuscript M, a change of the color determination value Lc, a change of the monochrome determination value Lm, the color/monochrome determination value LI, the difference threshold Th, the divisional determination values Ld, a deemed determination result, and selection instructions.

FIG. 9 illustrates an adjustment example in which a plurality of manuscripts M are read and the color determination value Lc and the monochrome determination value Lm are changed to the color/monochrome determination value LI. FIG. 9 illustrates the color data CD of each of fifteen manuscripts M. In FIG. 9, the plurality of pieces of color data CD corresponding to the fifteen manuscripts M are represented as eleventh color data CD11 to twenty-fifth color data CD25 in the read order.

In the adjustment example illustrated in FIG. 9, the determination value interval region LA is divided into a plurality of divisional determination regions. In FIG. 9, the determination value interval region LA is divided into four divisional determination regions. The four divisional determination regions are separated by the initial color determination value Lc, the initial monochrome determination value Lm, and the plurality of divisional determination values Ld. The plurality of divisional determination values Ld are values within the determination value interval region LA. The plurality of divisional determination values Ld illustrated in FIG. 9 are the first divisional determination value Ld1, the second divisional determination value Ld2, and the third divisional determination value Ld3. The manuscript determination section 144 performs color/monochrome determination and determination value adjustment using the color determination value Lc, the monochrome determination value Lm, and the plurality of divisional determination values Ld.

The first divisional determination value Ld1 is the divisional determination value Ld that is closest to the color determination value Lc. The first divisional determination value Ld1 is set as a deemed color determination value. The first divisional determination value Ld1 corresponds to an example of a first deemed determination threshold. The second divisional determination value Ld2 is the divisional determination value Ld that is closer to the monochrome determination value Lm than is the first divisional determination value Ld1. The third divisional determination value Ld3 is the divisional determination value Ld that is closer to the monochrome determination value Lm than are the first divisional determination value Ld1 and the second divisional determination value Ld2, and is closest to the monochrome determination value Lm. The third divisional determination value Ld3 is set as a deemed monochrome determination value. The third divisional determination value Ld3 corresponds to an example of a second deemed determination threshold. The first divisional determination value Ld1, the second divisional determination value Ld2, and the third divisional determination value Ld3 are stored in advance in the storage unit 90.

The divisional determination regions are each preset to a predetermined level size Lvt. The level size Lvt illustrated in FIG. 9 is a value obtained by dividing the determination value interval region LA into four equal parts. The manuscript determination section 144 uses the level size Lvt for color/monochrome determination.

Each piece of color data CD is compared with the color determination value Lc and the monochrome determination value Lm. The manuscript determination section 144 calculates a color difference ΔLct between the color data CD and the color determination value Lc for each manuscript M. The manuscript determination section 144 calculates a monochrome difference ΔLmt between the color data CD and the monochrome determination value Lm for each manuscript M. FIG. 9 illustrates, as an example, the color difference ΔLct between the sixteenth color data CD16 and the color determination value Lc, and the monochrome difference ΔLmt between the sixteenth color data CD16 and the monochrome determination value Lm.

The manuscript determination section 144 compares the color difference ΔLct with the level size Lvt. When the color difference ΔLct is less than the level size Lvt, the manuscript determination section 144 determines that the color data CD is closer to the color determination value Lc than is the first divisional determination value Ld1. The manuscript determination section 144 uses the first divisional determination value Ld1 as a deemed color determination value and determines that the manuscript M corresponding to the color data CD is a color manuscript.

The manuscript determination section 144 compares the monochrome difference ΔLmt with the level size Lvt. When the monochrome difference ΔLmt is less than the level size Lvt, the manuscript determination section 144 determines that the color data CD is closer to the monochrome determination value Lm than is the third divisional determination value Ld3. The manuscript determination section 144 uses the third divisional determination value Ld3 as a deemed monochrome determination value and determines that the manuscript M corresponding to the color data CD is a monochrome manuscript.

When the manuscript determination section 144 determines that the color difference ΔLct is greater than the level size Lvt and the monochrome difference ΔLmt is greater than the level size Lvt, the display control section 131 causes the display panel 15 to display the determination input screen 400. The input/output unit 11 accepts a selection instruction. The manuscript determination section 144 determines whether the manuscript M corresponding to the color data CD is a color manuscript or a monochrome manuscript on the basis of the selection instruction. The setting adjustment section 148 adjusts the color determination value Lc or the monochrome determination value Lm on the basis of the determination result.

The fifteenth color data CD15 illustrated in FIG. 9 is compared with the color determination value Lc and the monochrome determination value Lm. The manuscript determination section 144 calculates the color difference ΔLct between the fifteenth color data CD15 and the color determination value Lc. The manuscript determination section 144 calculates the monochrome difference ΔLmt between the fifteenth color data CD15 and the monochrome determination value Lm. The manuscript determination section 144 determines that the color difference ΔLct between the fifteenth color data CD15 and the color determination value Lc is less than the level size Lvt. The manuscript determination section 144 uses the first divisional determination value Ld1 as the deemed color determination value, and determines that the manuscript M corresponding to the fifteenth color data CD15 is a color manuscript. When the manuscript determination section 144 performs color/monochrome determination using the deemed color determination value, the setting adjustment section 148 does not adjust the color determination value Lc.

The sixteenth color data CD16 illustrated in FIG. 9 is compared with the color determination value Lc and the monochrome determination value Lm. The manuscript determination section 144 calculates the color difference ΔLct between the sixteenth color data CD16 and the color determination value Lc. The manuscript determination section 144 calculates the monochrome difference ΔLmt between the sixteenth color data CD16 and the monochrome determination value Lm. The manuscript determination section 144 determines that the color difference ΔLct between the sixteenth color data CD16 and the color determination value Lc is greater than or equal to the level size Lvt. The manuscript determination section 144 determines that the monochrome difference ΔLmt between the sixteenth color data CD16 and the monochrome determination value Lm is greater than the level size Lvt.

The display control section 131 causes the display panel 15 to display the determination input screen 400. The input/output unit 11 accepts a selection instruction to select a color manuscript. The manuscript determination section 144 determines that the manuscript M corresponding to the sixteenth color data CD16 is a color manuscript on the basis of the selection instruction to select a color manuscript. The setting adjustment section 148 adjusts the color determination value Lc. The setting adjustment section 148 sets the value of the sixteenth color data CD16 as the color determination value Lc. The adjusted color determination value Lc is the value of the sixteenth color data CD16.

After adjusting the color determination value Lc, the setting adjustment section 148 compares the difference between the adjusted color determination value Lc and the monochrome determination value Lm with the difference threshold Th. In the adjustment example illustrated in FIG. 9, the value obtained by doubling the level size Lvt is used as the difference threshold Th. The difference between the color determination value Lc adjusted by the sixteenth color data CD16 and the monochrome determination value Lm is greater than the difference threshold Th. The setting adjustment section 148 does not change the color determination value Lc and the monochrome determination value Lm to the color/monochrome determination value LI.

The nineteenth color data CD19 illustrated in FIG. 9 is compared with the color determination value Lc and the monochrome determination value Lm. The manuscript determination section 144 calculates the color difference ΔLct between the nineteenth color data CD19 and the color determination value Lc. The manuscript determination section 144 calculates the monochrome difference ΔLmt between the nineteenth color data CD19 and the monochrome determination value Lm. The manuscript determination section 144 determines that the color difference ΔLct between the nineteenth color data CD19 and the color determination value Lc is greater than the level size Lvt. The manuscript determination section 144 determines that the monochrome difference ΔLmt between the nineteenth color data CD19 and the monochrome determination value Lm is greater than the level size Lvt.

The display control section 131 causes the display panel 15 to display the determination input screen 400. The input/output unit 11 accepts a selection instruction to select a monochrome manuscript. The manuscript determination section 144 determines that the manuscript M corresponding to the nineteenth color data CD19 is a monochrome manuscript on the basis of the selection instruction to select a monochrome manuscript. The setting adjustment section 148 adjusts the monochrome determination value Lm. The setting adjustment section 148 sets the value of the nineteenth color data CD19 as the monochrome determination value Lm. The adjusted monochrome determination value Lm is the value of the nineteenth color data CD19.

After adjusting the monochrome determination value Lm, the setting adjustment section 148 compares the difference between the adjusted color determination value Lc and the adjusted monochrome determination value Lm with the difference threshold Th. The difference between the color determination value Lc adjusted by the sixteenth color data CD16 and the monochrome determination value Lm adjusted by the nineteenth color data CD19 is less than the difference threshold Th. The setting adjustment section 148 changes the color determination value Lc and the monochrome determination value Lm to the color/monochrome determination value LI. The color/monochrome determination value LI is set to, for example, an intermediate value between the value of the sixteenth color data CD16 and the value of the nineteenth color data CD19.

After changing the color determination value Lc and the monochrome determination value Lm to the color/monochrome determination value LI, the setting adjustment section 148 performs color/monochrome determination using the color/monochrome determination value LI. The setting adjustment section 148 uses the color/monochrome determination value LI to determine whether the manuscript M corresponding to the twentieth color data CD20 is a color manuscript or a monochrome manuscript.

The storage unit 90 stores the first divisional determination value Ld1 and the third divisional determination value Ld3, which is closer to the monochrome determination value Lm than is the first divisional determination value Ld1, within the determination value interval region LA. It is preferable that the manuscript determination section 144 compare the color data CD with the first divisional determination value Ld1, and upon determining that the color data CD is closer to the color determination value Lc than is the first divisional determination value Ld1, determine that the manuscript M is a color manuscript.

Since the first divisional determination value Ld1 is used for color/monochrome determination, the multifunction peripheral 1 can reduce the number of times the operator inputs a selection instruction. This improves the operator's convenience.

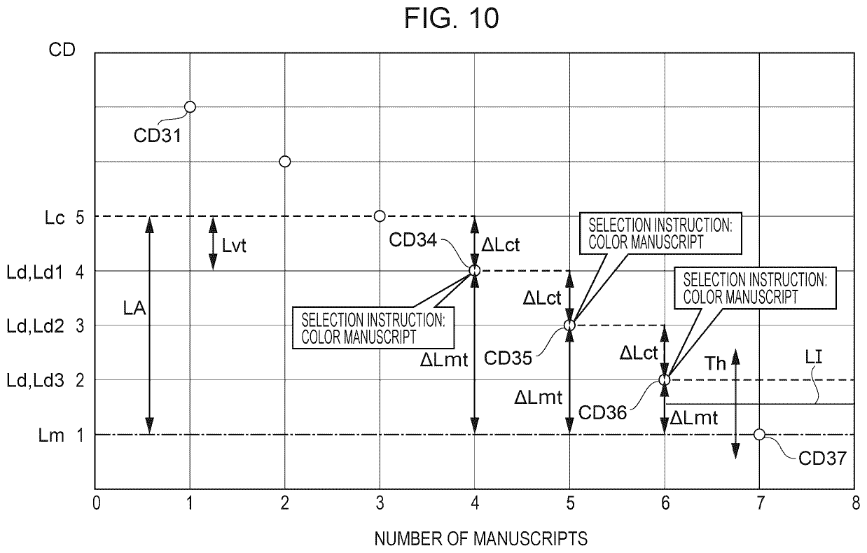

FIG. 10 illustrates an adjustment example in which a plurality of manuscripts M are read and the color determination value Lc and the monochrome determination value Lm are changed to the color/monochrome determination value LI. FIG. 10 illustrates the color data CD of each of seven manuscripts M. In FIG. 10, the plurality of pieces of color data CD corresponding to the seven manuscripts M are represented as thirty-first color data CD31 to thirty-seventh color data CD37 in the read order.

In the adjustment example illustrated in FIG. 10, the determination value interval region LA is divided into a plurality of divisional determination regions as in the adjustment example illustrated in FIG. 9. In FIG. 10, the determination value interval region LA is divided into four divisional determination regions. The four divisional determination regions are separated by the initial color determination value Lc, the initial monochrome determination value Lm, and the plurality of divisional determination values Ld. The plurality of divisional determination values Ld are values within the determination value interval region LA. The plurality of divisional determination values Ld illustrated in FIG. 10 are the first divisional determination value Ld1, the second divisional determination value Ld2, and the third divisional determination value Ld3. The manuscript determination section 144 performs color/monochrome determination using the color determination value Lc, the monochrome determination value Lm, and the plurality of divisional determination values Ld.

The thirty-fourth color data CD34 illustrated in FIG. 10 is compared with the color determination value Lc and the monochrome determination value Lm. The manuscript determination section 144 calculates the color difference ΔLct between the thirty-fourth color data CD34 and the color determination value Lc. The manuscript determination section 144 calculates the monochrome difference ΔLmt between the thirty-fourth color data CD34 and the monochrome determination value Lm. The manuscript determination section 144 determines that the color difference ΔLct between the thirty-fourth color data CD34 and the color determination value Lc is greater than or equal to the level size Lvt. The manuscript determination section 144 determines that the monochrome difference ΔLmt between the thirty-fourth color data CD34 and the monochrome determination value Lm is greater than the level size Lvt.

The display control section 131 causes the display panel 15 to display the determination input screen 400. The input/output unit 11 accepts a selection instruction to select a color manuscript. The manuscript determination section 144 determines that the manuscript M corresponding to the thirty-fourth color data CD34 is a color manuscript on the basis of the selection instruction to select a color manuscript. The setting adjustment section 148 adjusts the color determination value Lc. The setting adjustment section 148 sets the value of the thirty-fourth color data CD34 as the color determination value Lc. The adjusted color determination value Lc is the value of the thirty-fourth color data CD34.

After adjusting the color determination value Lc, the setting adjustment section 148 compares the difference between the adjusted color determination value Lc and the monochrome determination value Lm with the difference threshold Th. In the adjustment example illustrated in FIG. 10, the value obtained by doubling the level size Lvt is used as the difference threshold Th. The difference between the color determination value Lc adjusted by the thirty-fourth color data CD34 and the monochrome determination value Lm is greater than the difference threshold Th. The setting adjustment section 148 does not change the color determination value Lc and the monochrome determination value Lm to the color/monochrome determination value LI.

The thirty-fifth color data CD35 illustrated in FIG. 10 is compared with the color determination value Lc and the monochrome determination value Lm. The manuscript determination section 144 calculates the color difference ΔLct between the thirty-fifth color data CD35 and the color determination value Lc. The manuscript determination section 144 calculates the monochrome difference ΔLmt between the thirty-fifth color data CD35 and the monochrome determination value Lm. The manuscript determination section 144 determines that the color difference ΔLct between the thirty-fifth color data CD35 and the color determination value Lc is greater than the level size Lvt. The manuscript determination section 144 determines that the monochrome difference ΔLmt between the thirty-fifth color data CD35 and the monochrome determination value Lm is greater than the level size Lvt.

The display control section 131 causes the display panel 15 to display the determination input screen 400. The input/output unit 11 accepts a selection instruction to select a color manuscript. The manuscript determination section 144 determines that the manuscript M corresponding to the thirty-fifth color data CD35 is a color manuscript on the basis of the selection instruction to select a color manuscript. The setting adjustment section 148 adjusts the color determination value Lc. The setting adjustment section 148 sets the value of the thirty-fifth color data CD35 as the color determination value Lc. The adjusted color determination value Lc is the value of the thirty-fifth color data CD35.

After adjusting the color determination value Lc, the setting adjustment section 148 compares the difference between the adjusted color determination value Lc and the monochrome determination value Lm with the difference threshold Th. The difference between the color determination value Lc adjusted by the thirty-fifth color data CD35 and the monochrome determination value Lm is greater than the difference threshold Th. The setting adjustment section 148 does not change the color determination value Lc and the monochrome determination value Lm to the color/monochrome determination value LI.

The thirty-sixth color data CD36 illustrated in FIG. 10 is compared with the color determination value Lc and the monochrome determination value Lm. The manuscript determination section 144 calculates the color difference ΔLct between the thirty-sixth color data CD36 and the color determination value Lc. The manuscript determination section 144 calculates the monochrome difference ΔLmt between the thirty-sixth color data CD36 and the monochrome determination value Lm. The manuscript determination section 144 determines that the color difference ΔLct between the thirty-sixth color data CD36 and the color determination value Lc is greater than the level size Lvt. The manuscript determination section 144 determines that the monochrome difference ΔLmt between the thirty-sixth color data CD36 and the monochrome determination value Lm is greater than or equal to the level size Lvt.

The display control section 131 causes the display panel 15 to display the determination input screen 400. The input/output unit 11 accepts a selection instruction to select a color manuscript. The manuscript determination section 144 determines that the manuscript M corresponding to the thirty-sixth color data CD36 is a color manuscript on the basis of the selection instruction to select a color manuscript. The setting adjustment section 148 adjusts the color determination value Lc. The setting adjustment section 148 sets the value of the thirty-sixth color data CD36 as the color determination value Lc. The adjusted color determination value Lc is the value of the thirty-sixth color data CD36.

After adjusting the color determination value Lc, the setting adjustment section 148 compares the difference between the adjusted color determination value Lc and the monochrome determination value Lm with the difference threshold Th. The difference between the color determination value Lc adjusted by the thirty-sixth color data CD36 and the monochrome determination value Lm is less than the difference threshold Th. The setting adjustment section 148 changes the color determination value Lc and the monochrome determination value Lm to the color/monochrome determination value LI. The color/monochrome determination value LI is set to, for example, an intermediate value between the value of the thirty-sixth color data CD36 and the value of the monochrome determination value Lm.

What is claimed is:

1. An image processing apparatus comprising:
a scanning section configured to read a manuscript;
a determination section configured to use a color determination threshold and a monochrome determination threshold to determine whether the manuscript is a color manuscript or a monochrome manuscript, the monochrome determination threshold being different from the color determination threshold;
a storage section configured to store the color determination threshold and the monochrome determination threshold; and
an adjustment section configured to adjust the color determination threshold and the monochrome determination threshold, wherein
the determination section is configured to accept a determination instruction from a user, upon determining that a color level of the manuscript is within a threshold interval region between the color determination threshold and the monochrome determination threshold, both inclusive,
the adjustment section is configured to adjust the color determination threshold or the monochrome determination threshold, based on the determination instruction, and
the adjustment section is configured to change the color determination threshold and the monochrome determination threshold to a color/monochrome determination threshold, when a difference between the color determination threshold and the monochrome determination threshold is less than or equal to a predetermined value.

2. The image processing apparatus according to claim 1, further comprising:
a display screen control section configured to cause a determination instruction screen to be displayed, the determination instruction screen being configured to prompt the determination instruction to be issued;
a display section configured to display the determination instruction screen; and
a timing section configured to measure a display elapsed time from when the determination instruction screen is displayed on the display section, wherein
the determination section is configured not to accept the determination instruction from the user, upon determining that the display elapsed time exceeds a predetermined waiting time.

3. The image processing apparatus according to claim 2, wherein
the determination section is configured to:
upon determining that the display elapsed time exceeds the predetermined waiting time before accepting the determination instruction from the user, compare the color level of the manuscript with the color determination threshold and the monochrome determination threshold; and
upon determining that the color level is closer to the color determination threshold than to the monochrome determination threshold, determine that the manuscript is the color manuscript, and upon determining that the color level is closer to the monochrome determination threshold than to the color determination threshold, determine that the manuscript is the monochrome manuscript.

4. The image processing apparatus according to claim 2, wherein
the display screen control section is configured not to cause the display section to display the determination instruction screen, after the adjustment section changes the color determination threshold and the monochrome determination threshold to the color/monochrome determination threshold.

5. The image processing apparatus according to claim 1, wherein
the storage section is configured to store a first deemed determination threshold and a second deemed determination threshold which are within the threshold interval region, the second deemed determination threshold being closer to the monochrome determination threshold than is the first deemed determination threshold, and
the determination section is configured to:
compare the color level with the first deemed determination threshold; and
upon determining that the color level is closer to the color determination threshold than is the first deemed determination threshold, determine that the manuscript is the color manuscript.

6. An image processing method comprising:
reading a manuscript;
using a color determination threshold and a monochrome determination threshold to determine whether the manuscript is a color manuscript or a monochrome manuscript, the monochrome determination threshold being different from the color determination threshold;
accepting a determination instruction from a user, upon determining that a color level of the manuscript is within a threshold interval region between the color determination threshold and the monochrome determination threshold, both inclusive;
adjusting the color determination threshold or the monochrome determination threshold, based on the determination instruction; and
changing the color determination threshold and the monochrome determination threshold to a color/monochrome determination threshold, when a difference between the color determination threshold and the monochrome determination threshold is less than or equal to a predetermined value.
